(19) United States
(12) Patent Application Publication
(10) Pub. No.: US 2025/0220034 A1
(43) Pub. Date: Jul. 3, 2025

(54) SYSTEMS AND METHODS FOR DETECTING VISUALLY SIMILAR EMAILS

(71) Applicant: Cisco Technology, Inc., San Jose, CA (US)

(72) Inventors: Omid Mirzaei, Reston, VA (US); Sachin Shukla, Fremont, CA (US); Shray Kapoor, Fremont, CA (US)

(21) Appl. No.: 18/786,766

(22) Filed: Jul. 29, 2024

Related U.S. Application Data
(60) Provisional application No. 63/614,993, filed on Dec. 27, 2023.

(51) Int. Cl. H04L 9/40

(52) U.S. Cl. CPC H04L 63/1425

(57) ABSTRACT

In one embodiment, a method includes rendering each of a plurality of emails to generate a plurality of images and processing each of the plurality of images to generate a plurality of processed images. The method also includes extracting a plurality of features from each of the plurality of processed images and encoding the plurality of features into a vector for each of the plurality of processed images to generate a plurality of vectors. The method further includes determining whether two or more of the plurality of vectors are visually similar.

### RELATED APPLICATION

This application claims the benefit under 35 U.S.C. § 119(e) of Provisional Patent Application No. 63/614,993, filed Dec. 27, 2023, the entire contents of which are hereby incorporated by reference as if fully set forth herein.

### TECHNICAL FIELD

The present disclosure relates generally to security networks, and more particularly, to systems and methods for detecting visually similar emails.

### BACKGROUND

The race between email threat defense solutions and the continually evolving techniques employed by threat actors is a relentless battle in the realm of cybersecurity. As security measures improve and detection mechanisms become more sophisticated, cybercriminals are quick to adapt, devising elusive methods to bypass these defenses. Specifically, with the inexpensive phishing-as-a-service kits (e.g., Caffeine, EvilProxy, and NakedPages) that are available, bad actors can gain access to a wide range of capabilities.

### BRIEF DESCRIPTION OF THE FIGURES

FIG. 1 illustrates a system for detecting visually similar emails, in accordance with certain embodiments.

FIG. 2 illustrates a screenshot of five visually similar emails that an existing security tool failed to detect over consecutive days, in accordance with certain embodiments.

FIG. 3 illustrates a screenshot of the first email of the five visually similar emails of FIG. 2, in accordance with certain embodiments.

FIG. 4 illustrates a screenshot of the second email of the five visually similar emails of FIG. 2, in accordance with certain embodiments.

FIG. 5 illustrates a screenshot of the third email of the five visually similar emails of FIG. 2, in accordance with certain embodiments.

FIG. 6 illustrates a screenshot of the fourth email of the five visually similar emails of FIG. 2, in accordance with certain embodiments.

FIG. 7 illustrates a screenshot of the fifth email of the five visually similar emails of FIG. 2, in accordance with certain embodiments.

FIG. 8 illustrates a method for detecting visually similar emails, in accordance with certain embodiments.

FIG. 9 illustrates a computer system, in accordance with certain embodiments.

### DESCRIPTION OF EXAMPLE EMBODIMENTS

### Overview

In an embodiment, a network component includes one or more processors and one or more computer-readable non-transitory storage media coupled to the one or more processors and including instructions that, when executed by the one or more processors, cause the network component to perform operations. The operations include rendering each of a plurality of emails to generate a plurality of images and processing each of the plurality of images to generate a plurality of processed images. The operations also include extracting a plurality of features from each of the plurality of processed images and encoding the plurality of features into a vector for each of the plurality of processed images to generate a plurality of vectors. The operations further include determining whether two or more of the plurality of vectors are visually similar.

In certain embodiments, rendering each of the plurality of emails includes rendering a HyperText Markup Language (HTML) source for each of the plurality of emails.

In some embodiments, each of the plurality of vectors captures a numerical representation of visual elements embedded within a single email.

In certain embodiments, the operations include grouping two or more of the plurality of vectors that are visually similar together using a clustering algorithm or a similarity threshold.

In some embodiments, processing each of the plurality of images includes normalizing each of the plurality of images to modify pixel values to adhere to a particular range and distribution and/or sharpening each of the plurality of images to accentuate edges and intricate details.

In certain embodiments, processing each of the plurality of images includes cropping each of the plurality of images to eliminate outer segments, the outer segments including an email header and redundant spaces surrounding a body of each of the plurality of images.

In some embodiments, the plurality of emails include historic emails and new emails. The historic emails represent emails have been manually reclassified to include correct labels (e.g., spam, phishing, and graymail labels). The plurality of new emails have been filtered to only include emails with one or more visual components.

In another embodiment, a method includes rendering each of a plurality of emails to generate a plurality of images and processing each of the plurality of images to generate a plurality of processed images. The method also includes extracting a plurality of features from each of the plurality of processed images and encoding the plurality of features into a vector for each of the plurality of processed images to generate a plurality of vectors. The method further includes determining whether two or more of the plurality of vectors are visually similar.

In yet another embodiment, one or more computer-readable non-transitory storage media embody instructions that, when executed by a processor, cause the processor to perform operations. The operations include rendering each of a plurality of emails to generate a plurality of images and processing each of the plurality of images to generate a plurality of processed images. The operations also include extracting a plurality of features from each of the plurality of processed images and encoding the plurality of features into a vector for each of the plurality of processed images to generate a plurality of vectors. The operations further include determining whether two or more of the plurality of vectors are visually similar.

Technical advantages of certain embodiments of this disclosure may include one or more of the following. Certain embodiments described herein improve the efficacy of email threat defense products by learning from past observations. Some embodiments detect emails that resemble any spam emails missed even once in the past. Certain embodiments generate results that serve as a memory for existing defense products. Since emails that are grouped together share structural similarity, they are most likely created using the same email kit. Certain embodiments described herein name and track emails kits. Email campaigns may share and/or reuse email kits. In certain embodiments, the generated results are used for campaign tracking purposes. In some embodiments, the email security tool allows for the retrieval of email screenshots based on their content rather than relying on metadata or tags. In some embodiments, the email security tool identifies duplicate or near-duplicate email screenshots in large datasets, which is useful for machine learning (ML) engines.

Certain embodiments described herein power visual search engines where users can search for images similar to a given query. For example, a security analyst may find an interesting blog post where the only information provided is a screenshot of a phishing email. The security analyst can download that image and then query the internal database to see if similar email exists in the email corpus. By reliably grouping together emails that share structural and content similarities, one email from each group can be shown to a security analyst from the reclassification feeds on a daily basis, and the security analyst can be asked to verify the integrity of labels assigned to emails by customers. In certain embodiments, the email security tool automatically labels unknown messages, which increases efficiency. The systems and methods described herein are designed to deliver efficient performance at an industry scale.

In terms of detection efficacy, the email security tool may convict more emails that would have been delivered to customers' mailboxes without a visual similarity detection method. In terms of threat intelligence, security researchers may leverage the disclosed systems and/or methods to discover visually similar emails and to update their detection engines accordingly. The email security tool may be used for deduplication of visual similar emails and can improve the efficacy of ML systems.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

The disclosure describes systems and methods for detecting visually similar emails. Threat actors are reusing email kits extensively. Similar email kits produce visually similar emails. Most phishing kits are found to be distributed and reused in whole or in part. Email kits offer attackers an easy way to curate and send emails to a larger audience, maximizing the impact of their email campaigns. These kits often provide a number of default email templates to make the process smoother and faster. However, threat actors are changing their infrastructure continuously, and current security tools fail to detect spam emails that share the same structure (or template).

Certain embodiments of this disclosure provide an email security tool for effective remediation of the continuous failure to detect emails that share visual characteristics (or templates) via structural and visual similarity analysis of emails. The email security tool pulls historic, classified emails (e.g., emails that that the previous security tool failed to detect and thus were reclassified by the customer as spam, phishing, graymail, etc.). These reclassified emails are manually verified by the security team. The email security tool then embeds screenshots of these reclassified emails and stores them in a knowledge base. When a new email arrives, the new email is embedded in the same way as the historic emails, and a label is assigned to the new email based on the labels of visually lookalike emails that are stored in the knowledge base.

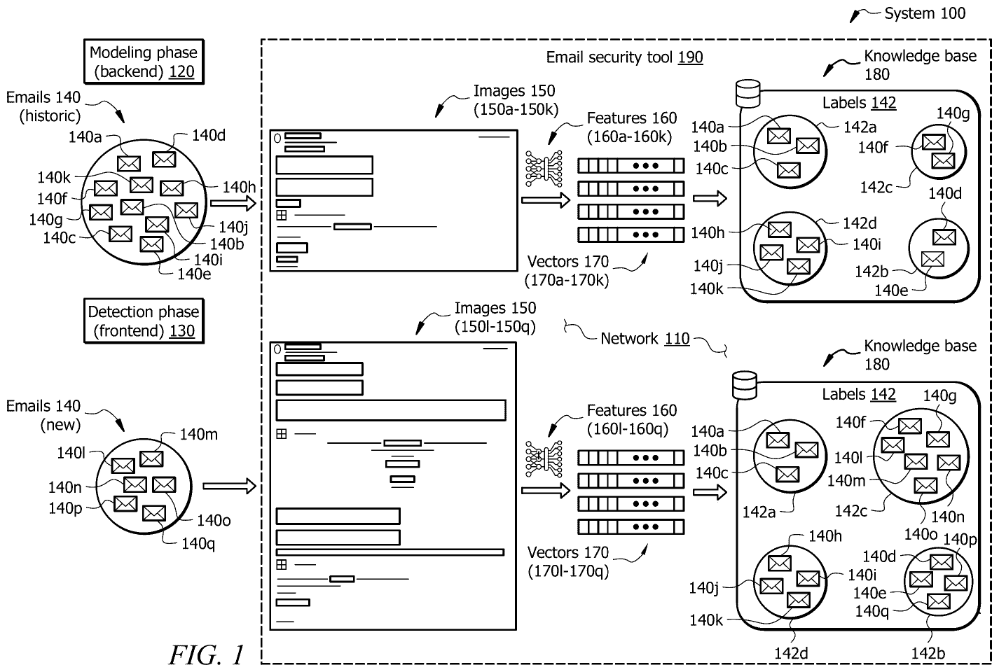

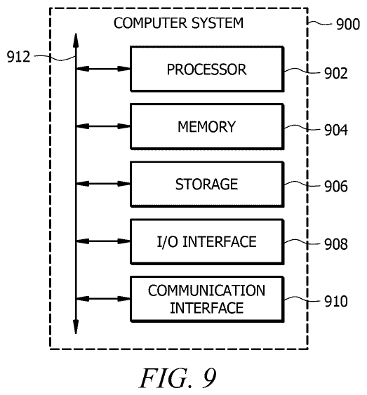

FIG. 1 illustrates a system 100 for detecting visually similar emails, in accordance with certain embodiments. System 100 or portions thereof may be associated with an entity, which may include any entity, such as a business or company that detects visually similar emails. The components of system 100 may include any suitable combination of hardware, firmware, and software. For example, the components of system 100 may use one or more elements of the computer system of FIG. 9. System 100 of FIG. 1 includes a network 110, a modeling phase 120, a detection phase 130, emails 140, images 150, features 160, vectors 170, a knowledge base 180, and an email security tool 190.

Network 110 of system 100 is any type of network that facilitates communication between components of system 100. Network 110 may connect one or more components of system 100. One or more portions of network 110 may include an ad-hoc network, an intranet, an extranet, a virtual private network (VPN), a local area network (LAN), a wireless LAN (WLAN), a wide area network (WAN), a wireless WAN (WWAN), a software-defined WAN (SD-WAN), a metropolitan area network (MAN), a portion of the Internet, a portion of the Public Switched Telephone Network (PSTN), a cellular telephone network, a Digital Subscriber Line (DSL), a Wi-Fi network, a 3G network, a 4G network, a 5G network, a Long Term Evolution (LTE) network, a combination of two or more of these, or other suitable types of networks. Network 110 may include one or more different types of networks. Network 110 may be any communications network, such as a private network, a public network, a connection through Internet, a mobile network, etc. One or more components of system 100 may communicate over network 110. Network 110 may include a core network (e.g., the Internet), an access network of a service provider, an Internet service provider (ISP) network, and the like. In certain embodiments, network includes one or more nodes. Node of network 110 represent any suitable computing components (e.g., a gateway, a router, a server, a controller, etc.) that can receive, create, process, store, and/or send traffic to other components within network 110. Nodes may be controlled by an entity (e.g., an email security provider).

Modeling phase 120 of system 100 is a software development phase that occurs on the backend. During modeling phase 120, historic emails 140 (emails 140a through 140k) are reclassified with appropriate labels 142 (labels 142a though 142d), processed, and stored in knowledge base 170 in accordance with their labels 142.

Detection phase 130 of system 100 is a software development phase that occurs on the frontend. During detection phase 130, new emails 140 (emails 140l though 140q) are processed and compared to historic emails 140 (emails 140a through 140k) that are stored in knowledge base 170 to determine whether any new emails 140 match any historic emails 140.

Emails 140 of system 100 represent electronic messages that are transmitted and received via electronic devices. In the illustrated embodiment of FIG. 1, emails 140 are transmitted across network 110 (e.g., the Internet or a LAN). Nodes (e.g., email servers, end user devices, gateways, etc.) within network 110 may accept, forward, deliver, and/or store emails 140. In certain embodiments, each email 140 includes content. The content may include a header and a body. The header of each email 140 is structured into fields (e.g., From, To, Carbon copy (Cc), Subject, Date, etc.). The ‘From’ field may include an email address and/or a name of the author(s). The ‘To’ field may include the address of email 140 and/or a name(s) of the recipient(s) of email 140. The ‘Subject’ field may include a brief summary of the topic of email 140. The ‘Date’ field may include a local time and a date that email 140 was written. The body of each email 140 includes a message. The body may use plain text or HTML. The body may include visual artifacts (e.g., images, graphics, etc.), in-line links, images, block quotes, underlined/italicized text, different font styles, and the like. Emails 140 include historic emails 140 and new emails 140.

Historic emails (email 140a through email 140k) include emails 140 that were previously misclassified. Emails 140 may be misclassified due to threat actors reusing email kits that can bypass detection with little effort. For example, threat actors may send emails from younger domains that do not have a rich history to be identified as anomalous by services that rely on historical data. Historic emails 140 may include emails 140 that were originally misclassified and submitted to administrators and/or customers. Users (e.g., security personnel, administrators, customers, etc.) may reclassify historic emails 140 (emails 140a through 140k) to apply appropriate labels 142 (labels 142a though 142d). Historic emails 140 are used during modeling phase 120.

New emails 140 (emails 140l through 140q) include incoming emails 140 that have yet to be classified. In certain embodiments, new emails 140 are pre-filtered for visual components. For example, when new email 140l is received by email security tool 190, email security tool 190 may analyze new email 140l to determine whether new email 140l includes visual components. Visual components may include colors, images, graphics, animations, photos, logos, videos, interactive elements, Graphics Interchange Formats (GIFs), clips, stickers, visual elements that are created via HTML tags (e.g., creating Microsoft logo with <table> tag), and so on. In certain embodiments, email security tool 190 filters out new emails 140 that do not include visual components. For example, email security tool 190 may filter out emails 140 that only use plain text. New emails 140 are used during detection phase 130. System 100 may also filter emails 140 based on sender domains (e.g., a reputation of the domain, whether the domain has been seen before previously, and/or other telemetry that can be used to determine whether the sender domain has sent suspicious (e.g., malicious) emails 140 in the past.

Labels 142 of system 100 represent tools for organizing and managing emails 140. In In certain embodiments, labels 142 are used to classify emails 140 by type (e.g., ham, spam, graymail, phishing, spear-phishing, wire transfer phishing, etc.). Labels 142 may be assigned to emails 140. For example, as illustrated in FIG. 1, label 142a (ham) is assigned to emails 140a, 140b, and 140c, label 142b (phishing) is assigned to emails 140d and 140e, label 142c (graymail 1) is assigned to emails 140f and 140g, and label 142d (graymail 2) is assigned to emails 140h, 140i, 140j, and 140k. Graymail 1 and graymail 2 represent different types of graymail (e.g., bulk mail). For example, graymail 1 may represent marketing emails, and graymail 2 may represent newsletters. As another example, graymail 1 may represent subscription emails, and gray mail 2 may represent loyalty programs. In certain embodiments, email security tool 190 automatically assigns labels 170 to emails 140.

Images 150 (images 150a through 150q) of system 100 represent captured screenshots of emails 140. The initial step in the pipeline illustrated by system 100 of FIG. 1 involves capturing email screenshots. This process is crucial for extracting visual information that represents the appearance and layout of each email 140. System 100 utilizes automated tools to render the HTML source of each email 140 and to capture relevant portions of the fully rendered email.

In certain embodiments, a series of image processing steps are performed to standardize and/or enhance the quality and/or relevance of images 150. By incorporating these processing steps, system 100 can create consistent and normalized data for improved image embedding. The image processing steps may include one or more of the following: normalization, sharpening, and/or cropping.

Normalization is an image processing step that typically involves adjusting lighting and/or color variations. For example, normalization may include modifying pixel values of each image 150 to adhere to a particular range and/or distribution, often with the goal of enhancing contrast and/or standardizing intensity values. In certain embodiments, normalization techniques include histogram equalization and contrast stretching, both of which seek to reorganize pixel intensities across a wider spectrum, resulting in a visually appealing image.

Sharpening is an image processing step that augments the high-frequency elements within each image 150, thereby accentuating edges and intricate details. This enhancement is frequently accomplished through application of filters, such as the unsharp mask or sharpening filter, which operate by highlighting variations in intensity among neighboring pixels, ultimately intensifying the edges of each image 150. System 100 of FIG. 1 may utilize an adaptive approach to image sharpening. In contrast to conventional methods that uniformly enhance the sharpness of the entire image, adaptive sharpening tailors the degree of sharpness according to the content and features found in distinct areas of images 150. This technique customizes the sharpening effect to match the unique characteristics of each region, aiming to enhance overall image quality without introducing unwanted artifacts or noise. Adaptive sharpening proves especially beneficial for images 150 with diverse levels of detail, contributing to a visually pleasing and more natural appearance.

Cropping is an image processing step that focuses on the relevant content of each image 150. In certain embodiments, cropping includes choosing a designated area of interest of image 150 and discarding the remaining portions of image 150. For example, cropping may include eliminating outer segments of images 150 to preserve only the intended sections. Cropping may be leveraged in system 100 of FIG. 1 to discard the header of email 140, to remove the redundant white spaces surrounding the body of email 140, and the like.

Features 160 (features 160a through 160q) of system 100 are individual measurable properties or characteristics of images 150. Features 160 may include specific structures in the image (e.g., points, edges, objects, etc.), motion in sequences of images 150, shapes defined in terms of curves or boundaries between different regions of images 150, and so forth. By utilizing pre-trained models (e.g., neural networks, Convolutional Neural Networks (CNNs) vision transformers, or other sophisticated architectures), system 100 extracts meaningful features 160 from images 150 and encodes features 160 into vectors 170.

Vectors 170 (vectors 170a through 170q) of system 100 are representations (e.g. numerical representations) of sets of features 160 of images 150. A pre-trained model (e.g., a multimodal deep learning model such as Contrastive Language-Image Pre-Training developed by OpenAI) may be used to embed features 160 into vectors 170. In certain embodiments, each embedding vector 170 captures a numerical representation of features 160 embedded within image 150. If a group of two or more emails 140 yield similar vectors 170, this result suggests that the group of images 150 exhibit comparable visual characteristics. This similarity serves as an indicator that emails 140 have analogous visual elements and share common templates and/or visual layouts. Therefore, the embedding process streamlines the effective comparison and retrieval of visually similar emails.

Knowledge base 180 of system 100 represents a memory for storing information and data. In certain embodiments, knowledge base 180 is a centralized repository of information that is collected, organized, and/or shared by email security tool 190. In the illustrated embodiment of FIG. 1, knowledge base 180 stores emails 140 in accordance with their labels 142. For example, referring to FIG. 1, emails 140a, 140b, and 140c are stored together in knowledge base 180 under label 142a, emails 140d and 140e are stored together in knowledge base 180 under label 142b, emails 140f and 140g are stored together in knowledge base 180 under label 142c, and emails 140h, 140i, 140j, and 140k are stored together in knowledge base 180 under label 142d. In certain embodiments, emails 140 are stored in the form of vectors 170. In some embodiments, certain information that is stored in knowledge base 180 is discarded after a certain period of time in accordance with one or more retention policies. For example, emails 140 may be time-stamped and discarded once the timestamp indicates the passage of a certain amount of time (e.g., 1 year, 5 years, etc.).

Email security tool 190 of system 100 represents any suitable software, application, hardware, or combination thereof that monitors emails 140 transmitted into network 110. In certain embodiments, email security tool 190 employs an image similarity detection and retrieval mechanism to identify visually similar emails 140 within knowledge base 180. For example, referring to FIG. 1, once a sufficient database of email embeddings is generated within knowledge base 180, email security tool 190 runs arriving new emails 140 (140l through 140q) through knowledge base 180. New emails 140l through 140q are convicted based on labels 142 of historic lookalike emails 140. In certain embodiments, email security tool 190 may use a fast nearest neighbor search algorithm to index a very large number of vectors 170. For example, when new email 140l arrives, the algorithm may rapidly identify the most similar images 150 from the indexed dataset based on their embedding vectors 170.

In certain embodiments, email security tool 190 uses a clustering algorithm or a similarity threshold to group visually similar emails 140 together. For example, referring to FIG. 1, email security tool 190 may group new emails 140p and 140q together with historic emails 140e and 140d in the event new emails 140p and 140q are visually similar to historic emails 140d and 140e. As another example, referring to FIG. 1, email security tool 190 may group new emails 140l, 140m, 140n, and 140o together with historic emails 140f and 140g in the event new emails 140l, 140m, 140n, and 140o are visually similar to historic emails 140f and 140g.

The similarity threshold may be based on a percentage (e.g., 90-95%) of similarities between two vectors 170. For example, cosine similarity may be used to measure the similarity between vectors 170d and 170q. If the similarities are greater than the similarity threshold, then email security tool 190 may determine that emails 140d and 140q corresponding to vectors 170d and 170q are visually similar. However, if the similarities are less than the similarity threshold, then email security tool 190 may determine that emails 140d and 140q corresponding to vectors 170d and 170q are not visually similar. In certain embodiments, system 100 implements a training phase to train email security tool 190 to accurately detect duplicate images 150. Email security tool 190 may remove duplicates to improve the process of machine learning.

In operation, email security tool 190 receives historic emails 140 (140a through 140k) during modeling phase 120 (backend) and captures images 150 of historic emails 140. Email security tool 190 then renders historic emails 140 using various imaging processing techniques (e.g., normalization, sharpening, cropping, etc.) to generate processed images 150. Email security tool 190 extracts features 160 from processed images 150 and embeds features 160 into vectors 170. An image similarity detection and retrieval mechanism then uses vectors 170 to identify visually similar emails 140 within knowledge base 180. As such, system 100 improves the efficacy of the email threat defense product by learning from past observations.

Although FIG. 1 illustrates a particular number of components, this disclosure contemplates any suitable number of components. Although FIG. 1 illustrates a particular arrangement of the components, this disclosure contemplates any suitable arrangement of the components. Furthermore, although FIG. 1 describes and illustrates particular components, devices, or systems carrying out particular actions, this disclosure contemplates any suitable combination of any suitable components, devices, or systems carrying out any suitable actions.

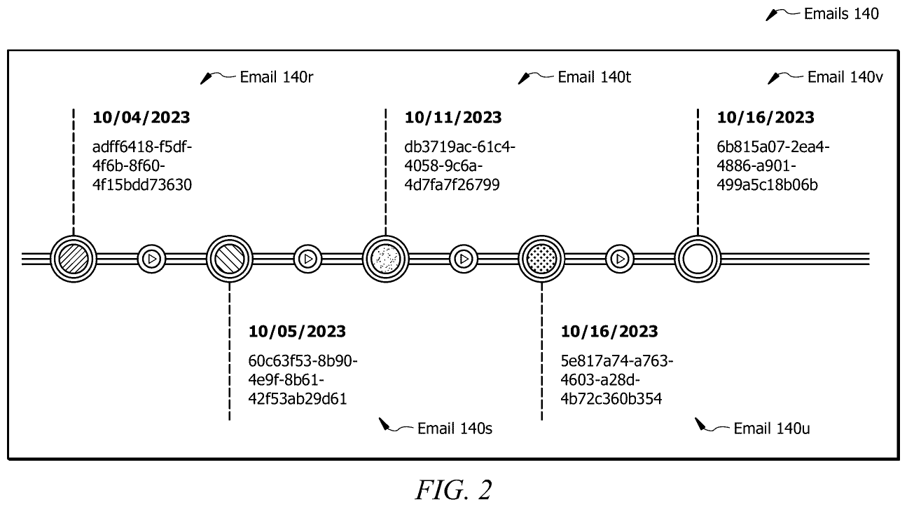

FIG. 2 illustrates a screenshot 200 of five visually similar emails 140 (emails 140r, 140s, 140t, 140u, and 140v) that an existing security tool failed to detect over consecutive days. A proof of concept was developed and run, and the results were analyzed for a period of one month (only business days were considered), starting from Sep. 11, 2023, to Oct. 23, 2023. The security tool detected 104 clusters of visually similar emails in the above period of time. The largest cluster included 308 emails (all of them were phishing emails), and the smallest cluster included 5 emails. The security tool detected 1,573 number of spam emails in a month that would have gone undetected without an image similarity detection method. A few false positives were detected and fixed by patching image processing scripts. While an image similarity detection method may not work very well for long emails that do not have any visual artifacts (i.e., text-only emails), a visual similarity detection method proved to work well in this application context.

Recurring failures (or mistakes) were identified by carefully examining phishing emails that security intelligence failed to detect over consecutive business days. Emails 140r through 140v with high structural and/or visual similarities (e.g., emails created with similar templates) were able to bypass detections and sit in users' inboxes one day after the other. This may have occurred due to: (1) an old threat actor changing their infrastructure but reusing the same email kit as a few days ago, or (2) different threat actors using the same email kit.

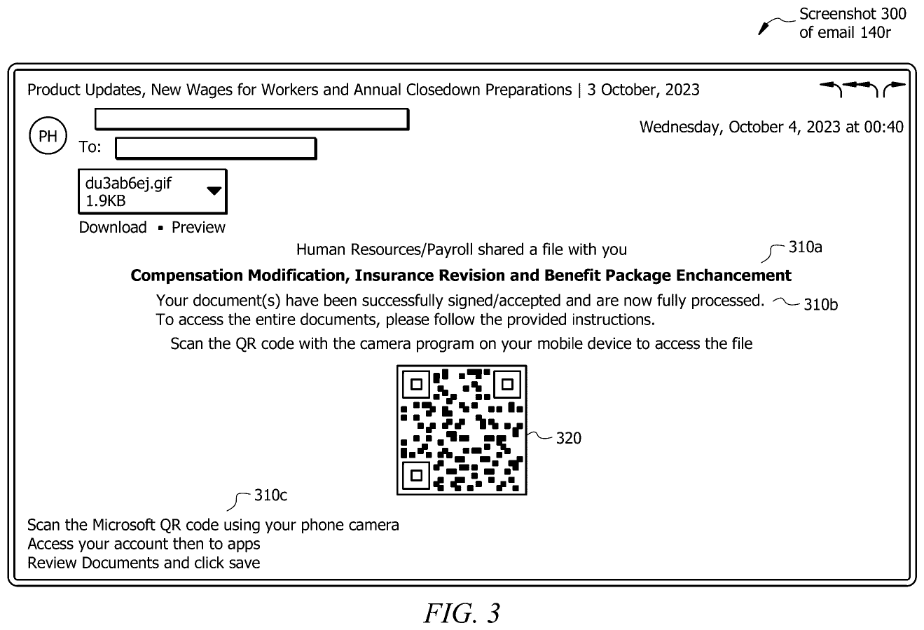

Emails 140r though 140v identified in FIG. 2 have very similar templates. For example, emails 140r though 140v have the same text and include quick-response (QR) codes that redirect users to phishing pages. However, the logos of emails 140r though 140v are different. Certain emails do not even have a logo (e.g., no logo in FIG. 3). To show the difference between emails 140r through 140v, screenshots of emails 140r through 140v are illustrated in FIG. 3 through FIG. 7, respectively, using meta-data information.

FIG. 3 illustrates a screenshot 300 of email 140r of FIG. 2, in accordance with certain embodiments. Email 140r is a QR code phishing email (email_id: adff6418-f5df-4f6b-8f60-4f15bdd73630) that the prior security tool failed to detect on Oct. 4, 2023. Email 140r includes the following text 310: (1) 310a (“Compensation Modification, Insurance Revision and Benefit Package Enhancement”); (2) 310b (“Your document(s) have been successfully signed/accepted and are now fully processed. To access the entire documents, please follow the provided instructions”); and (3) 310c (“Scan the Microsoft QR code using your phone camera. Access your account then to apps Review Documents and click save”). Screenshot 300 also includes QR code 320.

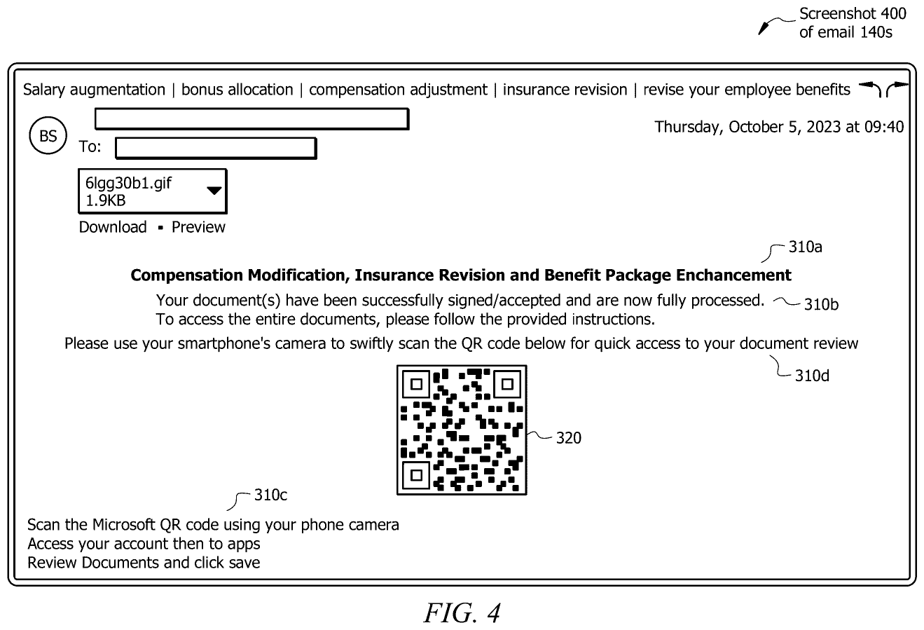

FIG. 4 illustrates a screenshot 400 of email 140s of FIG. 2, in accordance with certain embodiments. Email 140s is a QR code phishing email (email_id: 60c63f53-8b90-4e9f-8b61-42f53ab29d61) that the prior security tool failed to detect on Oct. 5, 2023. Email 140s includes the following text 310: 310a (“Compensation Modification, Insurance Revision and Benefit Package Enhancement”); 310b (“Your document(s) have been successfully signed/accepted and are now fully processed. To access the entire documents, please follow the provided instructions”); 310c (“Scan the Microsoft QR code using your phone camera. Access your account, then to apps Review Documents and click save”); and 310d (“Please use your smartphone's camera to swiftly scan the QR code below for quick access to your document review”). Text 310a, 310b, and 310c are also included in screenshot 300 of FIG. 3. Email 140s also includes QR code 320, which is also included in screenshot 300 of FIG. 3.

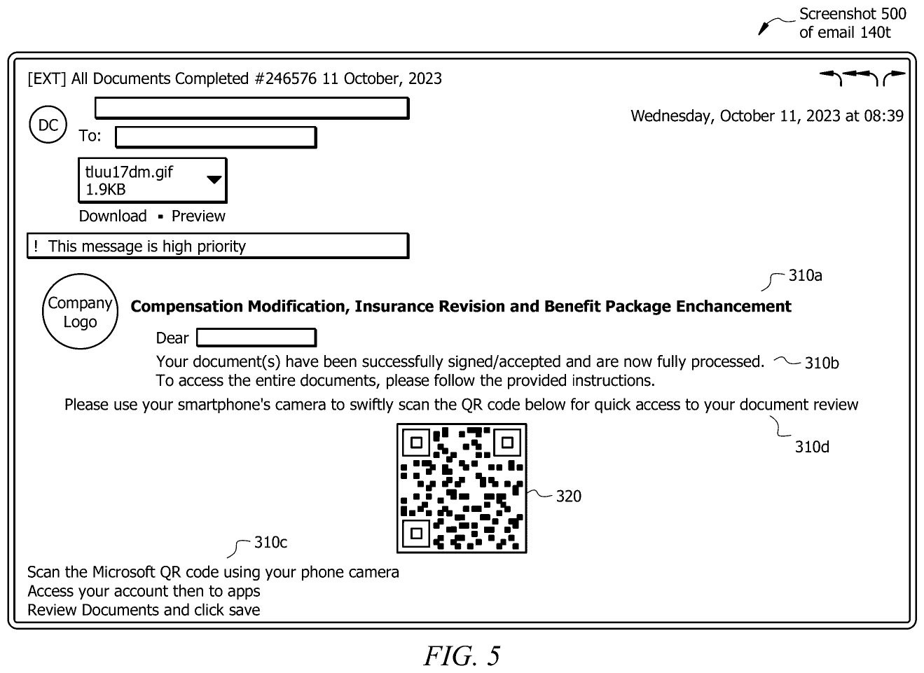

FIG. 5 illustrates a screenshot 500 of email 140t of FIG. 2, in accordance with certain embodiments. Email 140t is a QR code phishing email (email_id: db3719ac-61c4-4058-9c6a-4d7fa7f26799) that the prior security tool failed to detect on Oct. 11, 2023. Email 140t includes the following text 310: 310a (“Compensation Modification, Insurance Revision and Benefit Package Enhancement”); 310b (“Your document(s) have been successfully signed/accepted and are now fully processed. To access the entire documents, please follow the provided instructions”); 310c (“Scan the Microsoft QR code using your phone camera. Access your account, then to apps Review Documents and click save”); and 310d (“Please use your smartphone's camera to swiftly scan the QR code below for quick access to your document review”). Text 310a, 310b, 310c, and 310d are also included in screenshot 400 of FIG. 4. Email 140t also includes QR code 320, which is also included in screenshot 300 of FIG. 3 and screenshot 400 of FIG. 4. In addition, email 140t includes a company logo 510a, which is not shown in screenshot 300 or 400.

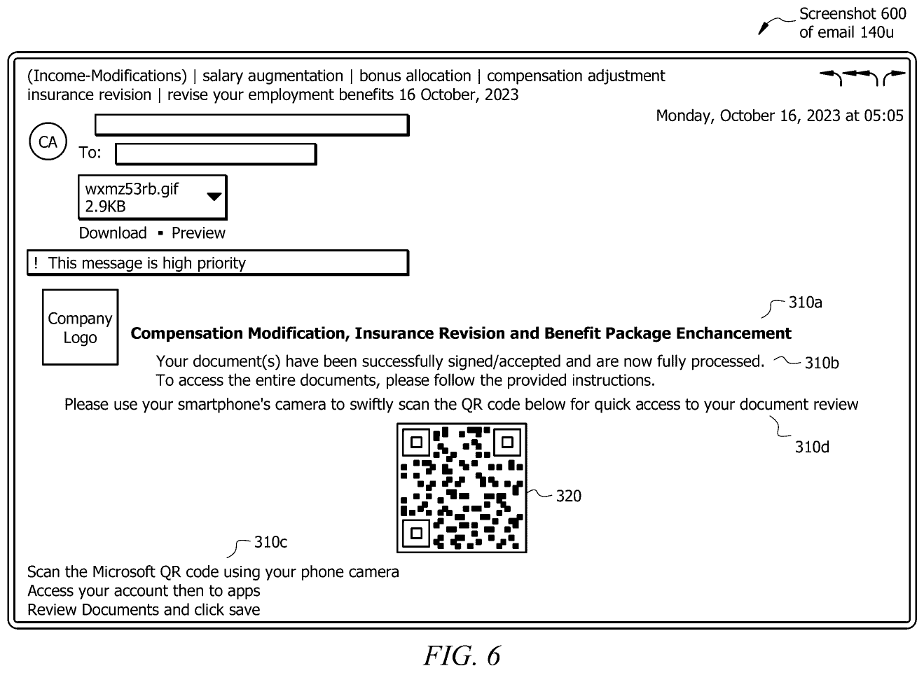

FIG. 6 illustrates a screenshot 600 of email 140u of FIG. 2, in accordance with certain embodiments. Email 140u is a QR code phishing email (email_id: 5e817a74-a763-4603-a28d-4b72c360b354) that the prior security tool failed to detect on Oct. 16, 2023. Email 140u includes the following text 310: 310a (“Compensation Modification, Insurance Revision and Benefit Package Enhancement”); 310b (“Your document(s) have been successfully signed/accepted and are now fully processed. To access the entire documents, please follow the provided instructions”); 310c (“Scan the Microsoft QR code using your phone camera. Access your account, then to apps Review Documents and click save”); and 310d (“Please use your smartphone's camera to swiftly scan the QR code below for quick access to your document review”). Text 310a, 310b, 310c, and 310d are also included in screenshot 400 of FIG. 4 and screenshot 500 of FIG. 5. Email 140u also includes QR code 320, which is also included in screenshot 300 of FIG. 3, screenshot 400 of FIG. 4, and screenshot 500 of FIG. 5. In addition, email 140u includes a company logo 510b, which is different than company logo 510a of screenshot 500.

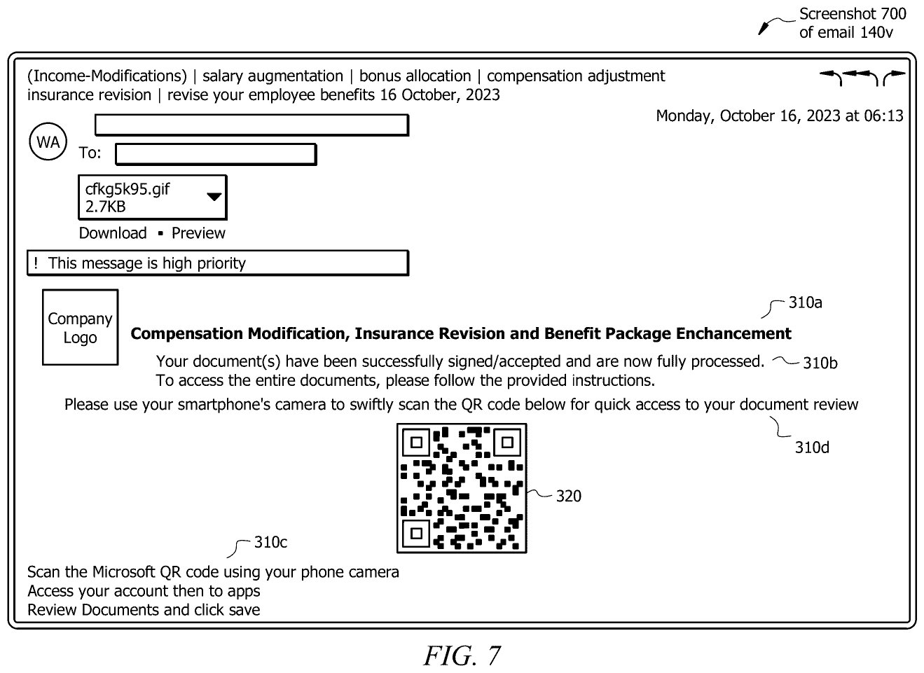

FIG. 7 illustrates a screenshot of 700 email 140v of FIG. 2, in accordance with certain embodiments. Email 140v is a QR code phishing email (email_id: 6b815a07-2ea4-4886-a901-499a5c18b06b) that the security tool failed to detect on Oct. 16, 2023. Email 140u includes the following text 310: 310a (“Compensation Modification, Insurance Revision and Benefit Package Enhancement”); 310b (“Your document(s) have been successfully signed/accepted and are now fully processed. To access the entire documents, please follow the provided instructions”); 310c (“Scan the Microsoft QR code using your phone camera. Access your account, then to apps Review Documents and click save”); and 310d (“Please use your smartphone's camera to swiftly scan the QR code below for quick access to your document review”). Text 310a, 310b, 310c, and 310d are also included in screenshot 400 of FIG. 4, screenshot 500 of FIG. 5, and screenshot 600 of FIG. 6. Email 140v also includes QR code 320, which is also included in screenshot 300 of FIG. 3, screenshot 400 of FIG. 4, screenshot 500 of FIG. 5, and screenshot 600 of FIG. 6. In addition, email 140u includes a company logo 510c, which is different than company logos 510a and 510b of screenshots 500 and 600, respectively.

As is evident from screenshots 300, 400, 500, 600, and 700 of FIG. 3 through FIG. 7, respectively, utilizing a visual similarity detection method can allow the email threat defense system to identify emails 140 resembling those that prior security tools may have failed to detect in the past. Screenshots 300, 400, 500, 600, and 700 confirm that email kits are being reused by threat actors. Visually similar emails 140 do not necessarily share similar subjects or bodies, rendering any content fuzzy hashing system less effective.

Although FIG. 2 though FIG. 7 illustrate a particular number of components within screenshot 200 through screenshot 700, respectively, this disclosure contemplates any suitable number of components. Although FIG. 2 though FIG. 7 illustrate a particular arrangement of the components within screenshot 200 through screenshot 700, respectively, this disclosure contemplates any suitable arrangement of the components. Furthermore, although FIG. 2 though FIG. 7 describe and illustrates particular components, devices, or systems carrying out particular actions, this disclosure contemplates any suitable combination of any suitable components, devices, or systems carrying out any suitable actions.

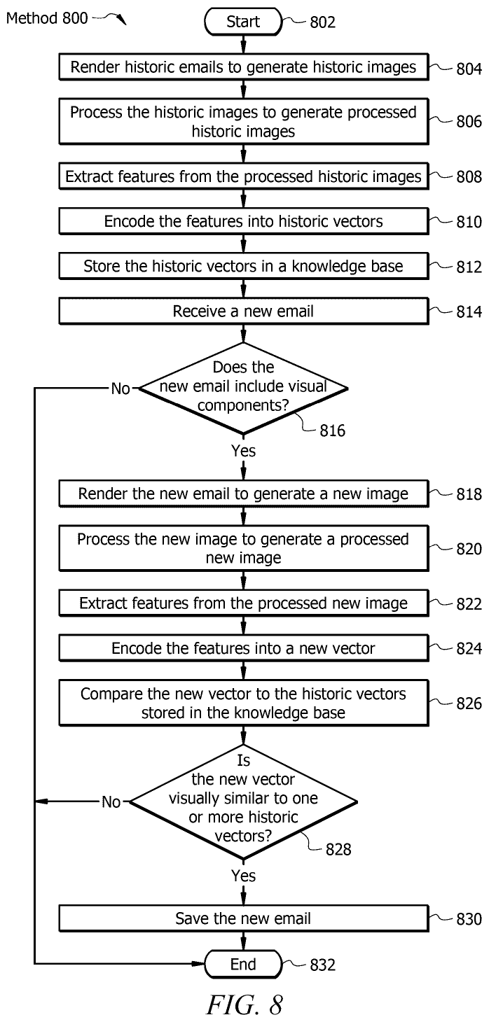

FIG. 8 illustrates a method for detecting visually similar emails, in accordance with certain embodiments. Method 800 begins in the modelling phase at step 802. At step 804, an email security tool renders historic emails to generate historic images. For example, referring to FIG. 1, email security tool 190 may capture screenshots of historic emails 140a though 140k to generate historic images 150a through 150k. This process is crucial for extracting visual information that represents the appearance and layout of historic emails 140. In certain embodiments, method 800 uses automated tools to render the HTML source of each historic email and to capture relevant portions of the fully rendered email. Method 800 then moves from step 804 to step 806.

At step 806 of method 800, the email security tool processes the historic images to generate processed historic images. For example, referring to FIG. 1, email security tool 190 may apply a series of image processing procedures to historic images 150a though 150k to generate processed historic images 150a though 150k. These image processing procedures may include normalization techniques to adjust lighting and color variations and cropping to focus on the relevant content. By incorporating these processing steps, method 800 aims to create a consistent and normalized data for improved image embedding. Method 800 then moves from step 806 to step 808.

At step 808 of method 800, the email security tool extracts features from the processed historic images. For example, referring to FIG. 1, email security tool 190 may utilize pre-trained models like CNNs or other sophisticated architectures to extract meaningful features 160a though 160k from processed historic images 150a through 150k. Method 800 then moves from step 808 to step 810, where the email security tool encodes the features into historic vectors. For example, referring to FIG. 1, email security tool 190 may leverage a pre-trained CLIP model to encode historic features 160a though 160k into historic vectors 170a though 170k. Each embedding vector 170 captures the numerical representation of the visual elements embedded within a single historic email 140. Method 800 then moves from step 810 to step 812.

At step 812 of method 800, the email security tool stores the historic vectors in a knowledge base. For example, referring to FIG. 1, email security tool 190 may store vectors 170 in knowledge base 180. Once a rich database of historic vectors 170 is created, method 800 advances from the modelling phase to the detection phase, which begins at step 814.

At step 814 of method 800, the email security tool receives a new email. For example, referring to FIG. 1, email security tool 190 may receive new email 140l from a client device. Method 800 then moves from step 814 to step 816, where the email security tool determines whether the new email includes visual components. For example, referring to FIG. 1, email security tool 190 may determine whether new email 140l includes visual components such as colors, logos, graphics, animations, photos, etc. Method 800 then moves from step 816 to step 818.

At step 818 of method 800, the email security tool renders the new email to generate a new image. For example, referring to FIG. 1, email security tool 190 may capture a screenshot of new email 140l to generate new image 150l. Method 800 then moves from step 818 to step 820, where the email security tool processes the new image to generate a processed image. For example, referring to FIG. 1, email security tool 190 may apply a series of image processing procedures to new image 150l to generate a processed new image 150l. These image processing procedures may include normalization techniques to adjust lighting and color variations and cropping to focus on the relevant content. Method 800 then moves from step 820 to step 822.

At step 822 of method 800, the email security tool extracts features from the processed new image. For example, referring to FIG. 1, email security tool 190 may utilize pre-trained models like CNNs or other sophisticated architectures to extract meaningful features 160lfrom processed new image 150l. Method 800 then moves from step 822 to step 824, where the email security tool encodes the features into new vectors. For example, referring to FIG. 1, email security tool 190 may leverage a pre-trained CLIP model to encode new features 160 into new vectors 170. Method 800 then moves from step 824 to step 826.

At step 826 of method 800, the email security tool compares the new vector to the historic vectors stored in the knowledge base to check for visual similarities. For example, referring to FIG. 1, email security tool 190 may compare new vector 1701 to historic vectors 170a though 170k stored in knowledge base 180. Method 800 then moves from step 826 to step 828, where the email security tool determines whether the new vector is visually similar to one or more of the historic vectors. For example, referring to FIG. 1, email security tool 190 may determine whether new vector 1701 is visually similar to one or more of historic vectors 170a though 170k. A determination that two emails 140 yield similar image embedding vectors 170 suggests that their screenshots exhibit comparable visual characteristics. This similarity serves as an indicator that emails 140 have analogous visual elements and share common templates or visual layouts.

If the email security tool determines that the new vector is not visually similar to one or more of the historic vectors saved in the knowledge base, method 800 advances from step 828 to step 832, where method 800 ends. If, at step 828, the email security tool determines that the new vector is visually similar to one or more of the historic vectors saved in the knowledge base, method 800 then moves from step 828 to step 830.

At step 830, the email security tool stores the new email in the knowledge base. For example, referring to FIG. 1, email security tool 190 may store vector 1701 in knowledge base 180. In certain embodiments, nearest neighbor search algorithms are used to index a large number of email embedding vectors 170. When a new email arrives, the algorithm may rapidly identify the most similar images 150 from the indexed dataset based on their embedding vectors 170. In some embodiments, visually similar emails are grouped together by leveraging either a clustering algorithm or a similarity threshold. Method 800 then moves from step 830 to step 832, where method 800 ends. As such, method 800 identifies duplicate or near-duplicate email screenshots in large datasets, which is useful for ML engines.

Although this disclosure describes and illustrates particular steps of the method of FIG. 8 as occurring in a particular order, this disclosure contemplates any suitable steps of method 800 of FIG. 8 occurring in any suitable order. Moreover, although this disclosure describes and illustrates an example method for detecting visually similar emails including the particular steps of method 800 of FIG. 8, this disclosure contemplates any suitable method for detecting visually similar emails including any suitable steps, which may include all, some, or none of the steps of method 800 of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of method 800 of FIG. 8.

FIG. 9 illustrates an example computer system 900. In particular embodiments, one or more computer system 900 perform one or more steps of one or more methods described or illustrated herein. In particular embodiments, one or more computer system 900 provide functionality described or illustrated herein. In particular embodiments, software running on one or more computer system 900 performs one or more steps of one or more methods described or illustrated herein or provides functionality described or illustrated herein. Particular embodiments include one or more portions of one or more computer system 900. Herein, reference to a computer system may encompass a computing device, and vice versa, where appropriate. Moreover, reference to a computer system may encompass one or more computer systems, where appropriate.

This disclosure contemplates any suitable number of computer system 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer system 900; be unitary or distributed; span multiple locations; span multiple machines; span multiple data centers; or reside in a cloud, which may include one or more cloud components in one or more networks. Where appropriate, one or more computer system 900 may perform without substantial spatial or temporal limitation one or more steps of one or more methods described or illustrated herein. As an example, and not by way of limitation, one or more computer system 900 may perform in real time or in batch mode one or more steps of one or more methods described or illustrated herein. One or more computer system 900 may perform at different times or at different locations one or more steps of one or more methods described or illustrated herein, where appropriate.

In particular embodiments, computer system 900 includes a processor 902, a memory 904, a storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer system 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications

(GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

What is claimed is:

1. A network component comprising one or more processors and one or more computer-readable non-transitory storage media coupled to the one or more processors and including instructions that, when executed by the one or more processors, cause the network component to perform operations comprising:
rendering each of a plurality of emails to generate a plurality of images;
processing each of the plurality of images to generate a plurality of processed images;
extracting a plurality of features from each of the plurality of processed images;
encoding the plurality of features into a vector for each of the plurality of processed images to generate a plurality of vectors; and
determining whether two or more of the plurality of vectors are visually similar.

2. The network component of claim 1, wherein rendering each of the plurality of emails comprises rendering a HyperText Markup Language (HTML) source for each of the plurality of emails.

3. The network component of claim 1, wherein each of the plurality of vectors captures a numerical representation of visual elements embedded within a single email.

4. The network component of claim 1, the operations further comprising grouping two or more of the plurality of vectors that are visually similar together using a clustering algorithm or a similarity threshold.

5. The network component of claim 1, wherein processing each of the plurality of images comprises:
normalizing each of the plurality of images to modify pixel values to adhere to a particular range and distribution; and
sharpening each of the plurality of images to accentuate edges and intricate details.

6. The network component of claim 1, wherein processing each of the plurality of images comprises cropping each of the plurality of images to eliminate outer segments, the outer segments including an email header and redundant spaces surrounding a body of each of the plurality of images.

7. The network component of claim 1, the operations further comprising:
the plurality of emails comprise historic emails and new emails;
the historic emails represent emails that have been manually reclassified to include correct labels, the correct labels comprising spam, phishing, and graymail labels; and
the plurality of new emails have been filtered to only include emails with one or more visual components.

8. A method, comprising:
rendering each of a plurality of emails to generate a plurality of images;
processing each of the plurality of images to generate a plurality of processed images;
extracting a plurality of features from each of the plurality of processed images;
encoding the plurality of features into a vector for each of the plurality of processed images to generate a plurality of vectors; and
determining whether two or more of the plurality of vectors are visually similar.

9. The method of claim 8, wherein rendering each of the plurality of emails comprises rendering a HyperText Markup Language (HTML) source for each of the plurality of emails.

10. The method of claim 8, wherein each of the plurality of vectors captures a numerical representation of visual elements embedded within a single email.

11. The method of claim 8, further comprising grouping two or more of the plurality of vectors that are visually similar together using a clustering algorithm or a similarity threshold.

12. The method of claim 8, wherein processing each of the plurality of images comprises:
normalizing each of the plurality of images to modify pixel values to adhere to a particular range and distribution; and
sharpening each of the plurality of images to accentuate edges and intricate details.

13. The method of claim 8, wherein processing each of the plurality of images comprises cropping each of the plurality of images to eliminate outer segments, the outer segments including an email header and redundant spaces surrounding a body of each of the plurality of images.

14. The method of claim 8, further comprising:
the plurality of emails comprise historic emails and new emails;
the historic emails represent emails that have been manually reclassified to include correct labels, the correct labels comprising spam, phishing, and graymail labels; and
the plurality of new emails have been filtered to only include emails with one or more visual components.

15. One or more computer-readable non-transitory storage media embodying instructions that, when executed by a processor, cause the processor to perform operations comprising:
rendering each of a plurality of emails to generate a plurality of images;
processing each of the plurality of images to generate a plurality of processed images;
extracting a plurality of features from each of the plurality of processed images;
encoding the plurality of features into a vector for each of the plurality of processed images to generate a plurality of vectors; and
determining whether two or more of the plurality of vectors are visually similar.

16. The one or more computer-readable non-transitory storage media of claim 15, wherein rendering each of the plurality of emails comprises rendering a HyperText Markup Language (HTML) source for each of the plurality of emails.

17. The one or more computer-readable non-transitory storage media of claim 15, wherein each of the plurality of vectors captures a numerical representation of visual elements embedded within a single email.

18. The one or more computer-readable non-transitory storage media of claim 15, the operations further comprising grouping two or more of the plurality of vectors that are visually similar together using a clustering algorithm or a similarity threshold.

19. The one or more computer-readable non-transitory storage media of claim 15, wherein processing each of the plurality of images comprises:
normalizing each of the plurality of images to modify pixel values to adhere to a particular range and distribution; and
sharpening each of the plurality of images to accentuate edges and intricate details.

20. The one or more computer-readable non-transitory storage media of claim 15, wherein processing each of the plurality of images comprises cropping each of the plurality of images to eliminate outer segments, the outer segments including an email header and redundant spaces surrounding a body of each of the plurality of images.
